(19) United States
(12) Patent Application Publication
(10) Pub. No.: US 2026/0201499 A1
(43) Pub. Date: Jul. 16, 2026

(54) METHOD FOR RECOVERING METALS FROM BATTERIES

(71) Applicants: HYUNDAI MOTOR COMPANY, Seoul (KR); KIA CORPORATION, Seoul (KR); UIF (University Industry Foundation), Yonsei University, Seoul (KR)

(72) Inventors: Jinyong Shim, Hwaseong-si (KR); Jae Eun Jin, Hwaseong-si (KR); Ju Heon Lee, Seoul (KR); Il Sohn, Seoul (KR); Sanghoon Lee, Seoul (KR)

(73) Assignees: HYUNDAI MOTOR COMPANY, Seoul (KR); KIA CORPORATION, Seoul (KR); UIF (University Industry Foundation), Yonsei University, Seoul (KR)

(21) Appl. No.: 19/200,117

(22) Filed: May 6, 2025

(30) Foreign Application Priority Data
Jan. 14, 2025 (KR) 10-2025-0005120

(51) Int. Cl. C22B 7/00; C01B 25/08; C01B 25/30; C22B 1/248; C22B 26/12; H01M 10/54

(52) U.S. Cl. CPC C22B 7/002; C01B 25/08; C01B 25/30; C22B 1/248; C22B 26/12; H01M 10/54; C01P 2002/72; C01P 2002/88

(57) ABSTRACT

A method for recovering metals from batteries providing for improved metal purity and recovery efficiency.

### CROSS-REFERENCE TO RELATED APPLICATION

This present application claims the benefit of priority to Korean Patent Application No. 10-2025-0005120, entitled “METHOD OF RECOVERING VALUABLE METALS FROM WASTED BATTERIES,” filed on Jan. 14, 2025, in the Korean Intellectual Property Office, the entire disclosure of which is incorporated herein by reference.

### FIELD

The present disclosure relates to a method for recovering metals from batteries such as, for example, valuable metals from waste or depleted batteries.

### BACKGROUND

Efforts to achieve carbon neutrality are being intensified worldwide, resulting in a rapid increase in the demand and supply of electric vehicles. Consequently, the production of lithium-ion secondary batteries (LIB) has risen, and the volume of waste batteries has also grown significantly. Under these circumstances, the importance of waste battery recycling technology is increasingly coming into focus.

Due to the high energy density of the lithium-ion secondary battery, the lithium-ion secondary battery offers advantageous characteristics for miniaturization and lightweight applications, enabling its widespread use in various fields. In particular, the lithium-ion secondary battery plays a crucial role as an energy storage device for electric vehicles. The typical lithium-ion secondary battery includes a separator, a current collector, a cathode active material, an anode active material, and an electrolyte, among other materials. Depending on the type of cathode active material used, the lithium-ion secondary battery is classified into various types. Among them, lithium iron phosphate (LFP)-based cathode active materials are in increasing demand worldwide, particularly in China, due to their high stability and low cost. In South Korea, the demand and supply of LFP-based cathode active materials are also expanding, mainly for entry-level electric vehicles. Accordingly, the need for battery recycling technology, including for LFP-based waste batteries, is also increasing.

LFP-based waste batteries exhibit higher structural stability compared to other cathode active material-based batteries, and this stability can make it difficult to separate the elements (e.g., for purposes of recycling/recovery). As a result, the recycling process is typically complex, leading to increased processing costs and reduced efficiency.

For example, current recycling processes for LFP-based batteries can be broadly classified into hydrometallurgical processes, direct recycling processes, and pyrometallurgical processes. The hydrometallurgical process enables the selective recovery of metals using acid, allowing for the recovery of high-purity metals. However, such methodology generates a large amount of acidic waste and has limitations in handling large-scale processing. The direct recycling process is a technology that regenerates cathode active materials by selectively separating them from batteries and heat-treating them with lithium compounds. This process enables recycling without structural decomposition of the cathode active materials, but requires an additional selective separation stage and is challenging for large-scale processing. The pyrometallurgical process is a technology that recovers metals through high-temperature heat treatment and has the advantage of enabling large-scale processing. However, existing pyrometallurgical process technologies involve treatment at high temperatures, such as 1500° C. and above, which leads to lithium loss. Therefore, there is a need for improvements these technologies, and particularly in the pyrometallurgical process, to address these problems.

The development of pyrometallurgical technology that is capable of large-scale processing while minimizing the loss of metals is key to achieving the commercialization of recycling technology for LFP-based batteries. In some specific examples, heat treatment technology in a reducing gas atmosphere may be applied for development of pyrometallurgical processes. Conventionally, mixed gases of carbon monoxide (CO) and carbon dioxide (CO₂) have been used as a reducing gas. However, such gases not only generate environmental pollutants but also impede progress toward carbon neutrality. To address such issues, it is necessary to develop technologies utilizing other reducing gas atmospheres, which may reduce pollution and contribute to achieving carbon neutrality. As demonstrated in the disclosure that follows, research and development of heat treatment technologies for LFP-based batteries in gas atmospheres containing hydrogen can be realized.

### SUMMARY

In general, the present disclosure provides a method for recovering metals, and in particular embodiments valuable metals, from batteries while minimizing lithium loss.

Additionally, in some embodiments, the present disclosure is directed to providing a method for recovering metals from batteries with improved efficiency.

In some embodiments, the present disclosure provides a method for recovering metals from batteries, which can be applied to green technology such as the recycling of LFP-based batteries used in electric vehicles.

In some aspects and embodiments, the present disclosure provides a method for recovering metals from a LiFePO₄ (LFP)-based lithium-ion battery, the method including providing or forming an atmosphere comprising hydrogen gas, and heat-treating the LFP-based lithium-ion battery in the hydrogen gas atmosphere, wherein the heat-treating is performed at a temperature ranging from 1000° C. to less than 1200° C.

In some embodiments, the atmosphere comprising hydrogen gas may include hydrogen, or hydrogen and an inert gas.

The hydrogen gas according to some embodiments of the present disclosure may include hydrogen in an amount of at least 50 wt. % based on the total weight of the atmosphere that comprises hydrogen gas.

In some embodiments of the method, the heat-treating in accordance with the present disclosure, can provide (i.e., recover) at least one material such as, for example, iron phosphide (Fe₂P) and/or lithium phosphate (Li₃PO₄).

According to some embodiments of the present disclosure, the LFP-based lithium-ion battery may include a carbon source.

According to some embodiments of the present disclosure, metals, and particularly valuable metals, can be recovered from batteries while minimizing lithium loss.

According to some embodiments, of the present disclosure, metals can be recovered with improved efficiency from batteries.

The present disclosure provides a number of advantages, as described herein, relative to the state of the art, but the advantages are not limited to only those advantages and effects specifically mentioned herein. One of skill will appreciate these advantages and effects, as well as other effects not specifically mentioned herein, in light of the following description.

### BRIEF DESCRIPTION OF THE DRAWINGS

The foregoing and other aspects, features, and advantages of the invention, as well as the following detailed description of various aspects and embodiments, will be better understood when read in conjunction with the accompanying drawings. For the purpose of illustrating the present disclosure, there is shown in the drawings exemplary embodiments, with the understanding that the present disclosure is not intended to be limited to the particular details illustrated, as various modifications and structural changes may be made therein without departing from the spirit of the present disclosure and within the scope and range of equivalents of the claims. Like reference numbers and designations in the various drawings indicate like elements.

FIG. 1 depicts a flowchart illustrating a method for recovering metals according to an embodiment of the present disclosure.

FIG. 2 shows the results of thermo-gravimetric analysis (TGA) on a recovered material according to an illustrative embodiment of the disclosure, as a function of heat treatment temperatures.

FIG. 3 shows the results of X-ray Diffraction (XRD) analysis on a recovered material according to an illustrative embodiment of the disclosure, as a function of heat treatment temperatures.

FIG. 4 shows the results of carbon sulfur (C/S) analysis on a recovered material according to an illustrative embodiment of the disclosure, as a function of heat treatment temperatures.

FIG. 5 shows the X-ray Diffraction (XRD) results for a recovered material at a heat treatment temperature of 1000° C., as a function on hydrogen content.

FIG. 6 shows the X-ray Diffraction (XRD) results for a recovered material at a heat treatment temperature of 1100° C., as a function of hydrogen content.

FIG. 7 shows the X-ray Diffraction (XRD) results for a recovered material at a heat treatment temperature of 1200° C., as a function of hydrogen content.

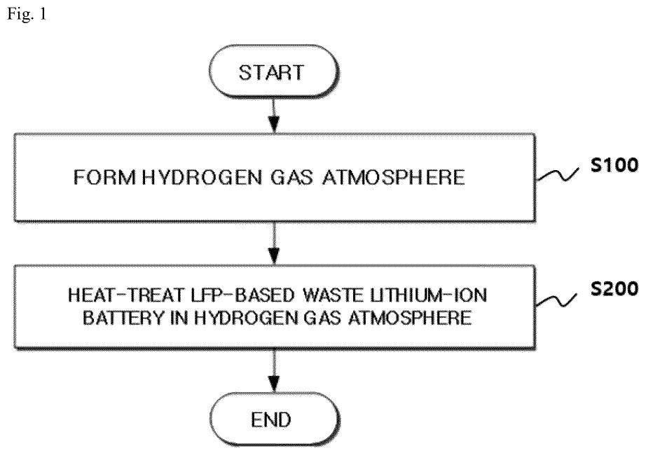

### DETAILED DESCRIPTION

The present disclosure will be described in further detail below with reference to exemplary embodiments. However, the following exemplary embodiments are provided merely as references for describing the present disclosure in further illustrative detail. The present disclosure is not intended to be limited to these particular details, and may be implemented in various forms.

Unless otherwise defined, all technical and scientific terms used herein have the same meaning as commonly understood by those skilled in the art to which the present disclosure pertains.

The terms used herein are intended merely to describe particular embodiments effectively and are not intended to limit the present disclosure.

Singular forms “a,” “an,” and “the” used in the specification and the appended claims are intended to include plural referents unless the context clearly dictates otherwise.

The units used in this specification, unless otherwise stated, are based on weight. For instance, the units such as “%” or “ratio” refer to weight percent (wt. %) or weight ratio, respectively. Unless otherwise defined, weight percent (wt. %) refers to the proportion of a specific component within the total composition, expressed as a percentage by weight.

When a portion is described as “including” or “comprising” a certain component, it means that, unless specifically stated to the contrary, the inclusion of other components is not excluded but rather that additional components may also be included. These terms are also understood to encompass terms that refer to embodiments that have “closed” language, for example “consisting of” and “consisting essentially of”, where such terms indicate that only the specifically recited features or elements are included, without additional components, or with only minor amounts of other components that do not have any substantial effect on the composition or method.

In addition, numerical ranges used in this specification may include all values between the lower and upper limits, all values incrementally derived logically within shape and breadth of the defined ranges, all double-limited values, and all possible combinations of upper and lower limits of differently limited numerical ranges. Unless specifically defined in this specification, values outside the defined numerical ranges that may occur due to experimental error or rounding off of values are also included within the defined numerical ranges.

In an aspect, the disclosure provides a method for recovering metals from a battery, and in some example embodiments, a valuable metal from a waste battery. In some embodiments the present disclosure relates to a method for recovering metals from a LiFePO₄ (LFP)-based lithium-ion battery, the method including providing or forming an atmosphere comprising hydrogen gas (or alternatively, a “hydrogen gas atmosphere”), and heat-treating the LFP-based lithium-ion battery in the hydrogen gas atmosphere, wherein the heat-treating is performed at a temperature ranging from 1000° C. to less than 1200° C.

In some embodiments, the forming (S100) the hydrogen gas atmosphere includes forming an environment inside a device in which the heat treating is performed, such as a furnace, such that hydrogen gas becomes the main atmosphere component, instead of air. In such embodiments, the hydrogen gas atmosphere provides a strong reduction power and a fast reaction rate for the metal(s) contained in the lithium-ion batteries during heat treatment. Such embodiments, as a result, can effectively induce the reduction of the metals at lower temperature while minimizing pollution.

In one embodiment of the present disclosure, the furnace may include a vertical firing furnace with a plurality of working sections. For example, the vertical firing furnace may be configured with an upper working section and a lower working section, each of which can be independently controlled. In such embodiments, the upper working section may be responsible for preheating the LFP-based lithium-ion battery, while the lower working section may perform the main heat-treating process. In some further embodiments, each working section is equipped with a gas supply unit and a gas discharge unit. In such embodiments, the gas supply unit can be configured to deliver an atmosphere comprising hydrogen gas, while the gas discharge unit can be configured to ensure the safe discharge of any used gas.

In one embodiment of the present disclosure, the furnace has a vertical firing furnace structure, which configuration can enable a continuous and uniform heat-treating process by, for example, moving a storage unit containing the LFP-based lithium-ion batteries in the vertical direction. In embodiments, the storage unit is sequentially heated by the heating sections of the furnace, during which hydrogen gas atmosphere (i.e., including hydrogen) may be supplied into the working section. Such a configuration can ensure that heat can be uniformly and efficiently transferred to the LFP-based lithium-ion batteries. In additional embodiments, the vertical firing furnace structure can help to optimize the flow of gases generated during the heat treatment process, enabling uniform heating of the LFP-based lithium-ion batteries and maximizing the efficiency of the heat treatment.

In embodiments, the gas supply unit supplies hydrogen gas (i.e., an atmosphere including hydrogen gas) into the working sections, while the gas discharge unit safely discharges the used gas, thereby maintaining optimal conditions within the working sections.

In one embodiment of the present disclosure, the furnace may include one or a plurality of heating units, which can be provided in a plurality corresponding to each working section. In embodiments, each heating section may be controlled depending on the measured temperature of its corresponding working section to ensure the target temperature in the section is maintained. In such configuration, the working sections of the furnace can precisely maintain various heat-treating conditions, enabling the effective reduction of the LFP-based lithium-ion batteries and the recovery of metals.

In one embodiment of the present disclosure, the atmosphere comprising hydrogen gas may include hydrogen, or it can comprise hydrogen and an additional gas such as, for example, an inert gas.

In one embodiment of the present disclosure, the inert gas may include at least one of argon (Ar), helium (He), neon (Ne), krypton (Kr), xenon (Xe), radon (Rn), and nitrogen (N₂), and in some specific embodiments, may include argon.

In some specific embodiments, the hydrogen gas atmosphere may include hydrogen in an amount of at least 50 wt. %, 60 wt. %, 70 wt. %, 80 wt. %, 90 wt. %, or 99 wt. % based on the total weight of the hydrogen gas atmosphere, and up to 100 wt. % (i.e., “consists of” or “consists essentially of” hydrogen gas). In embodiments that provide the above range, the reduction reaction may be easier to perform and enable efficient separation. In accordance with embodiments wherein the hydrogen content is less than 100 wt. %, the remaining portion of the atmosphere may comprise, or consist of, the inert gas.

In embodiments heat-treating(S200) the LFP-based lithium-ion battery in the hydrogen gas atmosphere may include reducing the metals contained in the LFP-based lithium-ion battery by heat-treating the LFP-based lithium-ion battery in a device where the hydrogen gas atmosphere is formed.

In one embodiment of the present disclosure, the heat-treating may be performed at a lower temperature limit of at least 950° C., 1000° C., 1100° C., or 1150° C., and an upper temperature limit of less than 1200° C. In embodiments wherein this range is satisfied, the reduction reaction can proceed efficiently even with a lower hydrogen content in the hydrogen gas atmosphere, leading to an improved recovery rate of metals.

In one embodiment of the present disclosure, the method can provide at least one recovered material such as, for example, iron phosphide (Fe₂P) and lithium phosphate (Li₃PO₄), any of which may be obtained by the heat-treating process. However, the material obtained is not limited to only these materials.

According to one embodiment of the present disclosure, the LFP-based lithium-ion battery may include a carbon source. In such embodiments, the carbon source can act as a reducing agent under the heat treatment conditions, allowing the reduction reaction to proceed efficiently even with a lower hydrogen content in the hydrogen gas, thereby improving the recovery rate of metals.

According to one embodiment of the present disclosure, the carbon source may include Carbon black, Acetylene black, Graphite, Carbon nanotube, and/or graphene.

In one embodiment of the present disclosure, the method for recovering metals from the LFP-based lithium-ion battery may further include pretreating the LFP-based lithium-ion battery, and crushing the pretreated LFP-based lithium-ion battery.

In embodiments, the pretreating the LFP-based lithium-ion battery can be performed for explosion prevention, hazard neutralization, and external casing removal of the lithium-ion battery. In some specific embodiments, since lithium-ion batteries, such as used lithium-ion batteries, are sealed systems containing electrolytes and other components inside, crushing the lithium-ion batteries in their original state creates a risk of explosion. Therefore, it is typically necessary to perform discharge treatment or removal of the electrolyte. As such, by removing the electrolyte and the outer casing in the pretreatment process of the batteries, it is possible to enhance the safety of the process and improve the recovery productivity of metals such as copper, nickel, and cobalt. In some embodiments, the discharge treatment can be performed by immersing the battery in an aqueous solution containing alkali metal or alkaline earth metal ions.

In embodiments comprising the crushing of the pretreated LFP-based lithium-ion battery, typically contents of the battery are crushed to obtain a crushed material. The crushing can be performed to improve the recovery rate of metals such as copper, nickel, and cobalt by enhancing the reaction efficiency in subsequent processes. The crushing method is not particularly limited, for example, it can be performed by crushing or cutting the battery contents using existing crushers, such as a cutter mixer or any other suitable methods generally known in the art.

In one embodiment of the present disclosure, the LFP-based lithium-ion battery may comprise a waste LFP-based lithium-ion battery.

In one embodiment of the present disclosure, the waste LFP-based lithium-ion battery may refer to a LFP-based lithium-ion battery that has reached the end of its useful life, is no longer suitable for its original intended purpose, and is subject to recycling, disposal, or resource recovery processes.

In addition, embodiments of the present disclosure may provide a metal recovered by the method for recovering metals from a lithium-ion battery.

Hereinafter, some illustrative and various embodiments of the present disclosure will be described. However, the following embodiments are merely exemplary embodiments of the present disclosure, and the present disclosure is not intended to be limited thereto.

### Example 1

To simulate an LFP-based waste battery, a simulated sample was prepared by mixing lithium iron phosphate (LiFePO₄) and graphite (C) at a weight ratio of 6:4. Next, a hydrogen gas atmosphere, having 100% wt. % hydrogen, was introduced into the interior of a furnace in which the crushed material was contained. Then, the recovered material was obtained from the simulated sample through heat-treatment at 1000° C. for 15 minutes.

### Example 2

Example 2 was performed in the same manner as in Example 1, except for performing the heat treatment at a temperature of 1100° C. for 15 minutes.

### Example 3

Example 3 was performed in the same manner as Example 1, except the hydrogen gas atmosphere in the interior of the furnace included 50 wt. % hydrogen and 50 wt. % argon.

### Example 4

xample 4 was performed in the same manner as Example 1, except the hydrogen gas atmosphere in the interior of the furnace included 75 wt. % hydrogen and 25 wt. % argon.

### Example 5

Example 5 was performed in the same manner as Example 2, except the hydrogen gas atmosphere in the interior of the furnace included 50 wt. % hydrogen and 50 wt. % argon.

### Example 6

Example 6 was performed in the same manner as Example 2, exceptthe hydrogen gas atmosphere in the interior of the furnace included 75 wt. % hydrogen and 25 wt. % argon,.

### Comparative Example 1

In this example, except for performing the heat treatment at a temperature of 700° C. for 15 minutes, Comparative Example 1 was performed in the same manner as in Example 1.

### Comparative Example 2

In this example, except for performing the heat treatment at a temperature of 800° C. for 15 minutes, Comparative Example 2 was performed in the same manner as in Example 1.

### Comparative Example 3

In this example, except for performing the heat treatment at a temperature of 900° C. for 15 minutes, Comparative Example 3 was performed in the same manner as in Example 1.

### Comparative Example 4

In this example, except for performing the heat treatment at a temperature of 1200° C. for 15 minutes, Comparative Example 4 was performed in the same manner as in Example 1.

### Comparative Example 5

In this example, except for including in the interior of the furnace a hydrogen gas atmosphere including 50 wt. % hydrogen and 50 wt. % argon, Comparative Example 5 was performed in the same manner as Comparative Example 4.

### Comparative Example 6

In this example, except for including in the interior of the furnace a hydrogen gas atmosphere including 75 wt. % hydrogen and 25 wt. % argon, Comparative Example 6 was performed in the same manner as Comparative Example 4.

### Experimental Example 1: Examination of Mass Changes in the Sample Depending on Heat Treatment Temperature

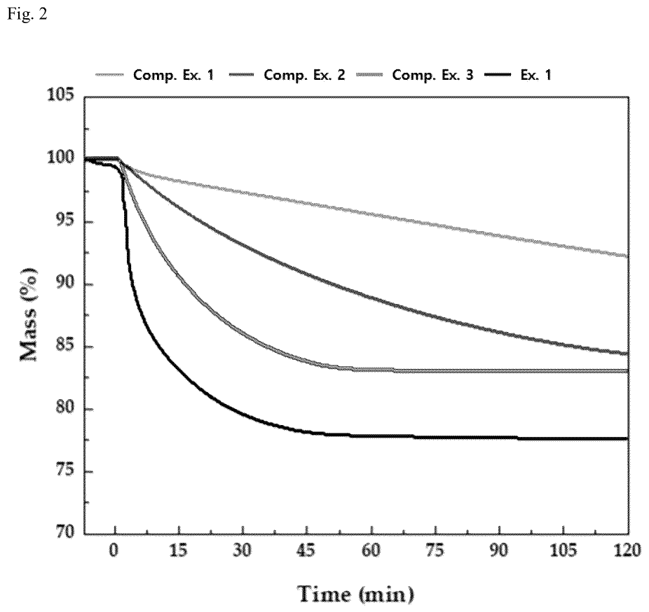

To examine the mass changes of the sample as a function of the heat treatment temperature, thermo-gravimetric analysis (TGA) was performed on the recovered material of the examples and comparative examples. Specifically, the simulated sample was heated to the target temperature in an inert gas atmosphere and then maintained at the target temperature under a hydrogen gas atmosphere consisting of 100 wt % hydrogen. The mass change of the simulated sample was measured over time, and the results are shown in FIG. 2.

As shown in FIG. 2, the sample of Comparative Example 1 did not exhibit any mass loss, indicating that the reduction reaction of lithium iron phosphate (LiFePO₄) did not occur. Furthermore, as the target temperature increased, the rate of mass loss also increased, indicating that higher heat treatment temperatures facilitate the separation of lithium iron phosphate (LiFePO₄). In particular, when the heat treatment temperature is 1000° C., a significant mass loss was observed during the temperature ramping process, indicating that the reduction reaction of lithium iron phosphate occurred even under an inert atmosphere.

### Experimental Example 2: Composition Analysis of the Sample Based on Heat Treatment Temperature

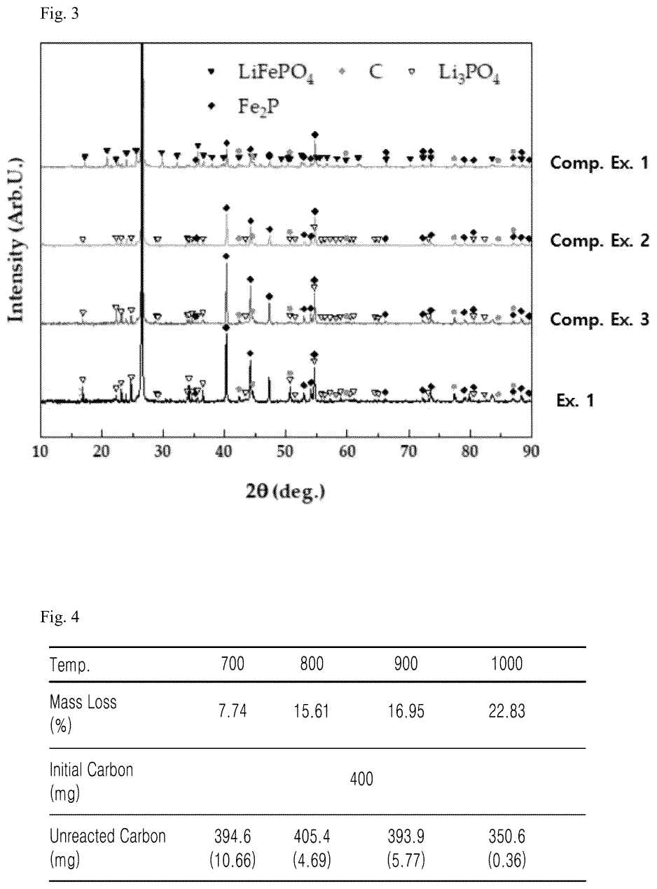

To identify the composition of the sample as a function of the heat treatment temperature, XRD analysis was performed on the heat-treated sample from Experimental Example 1, and the results are shown in FIG. 3.

As shown in FIG. 3, when the heat treatment temperature was 700° C., the peak of unreduced lithium iron phosphate (LiFePO₄) was observed, indicating that this temperature is unsuitable for reduction. In contrast, when the heat treatment temperature was 800° C. or higher, no peaks of unreduced lithium iron phosphate (LiFePO₄) were observed, indicating that lithium iron phosphate (LiFePO₄) was separated into iron phosphide (Fe₂P) and lithium phosphate (Li₃PO₄).

### Experimental Example 3: Carbon Content Analysis of the Sample Based on Heat Treatment Temperature

Carbon-sulfur (C/S) analyzer analysis was performed on the heat-treated sample from Experimental Example 1, and the results are shown in FIG. 4.

As shown in FIG. 4, at heat treatment temperatures of 900° C. or below, the amount of carbon present in the simulated sample remained unchanged before and after the heat treatment. However, the amount of carbon present in the simulated sample decreased after heat treatment at 1000° C. This indicates that at the heat treatment temperature of 1000° C., a reduction reaction occurred not only in a hydrogen gas atmosphere including or consisting of 100 wt. % hydrogen but also in an inert gas atmosphere through the reaction of the graphite present in the simulated sample.

### Experimental Example 4: Composition Analysis of the Sample Based on Heat Treatment Temperature and Hydrogen Content

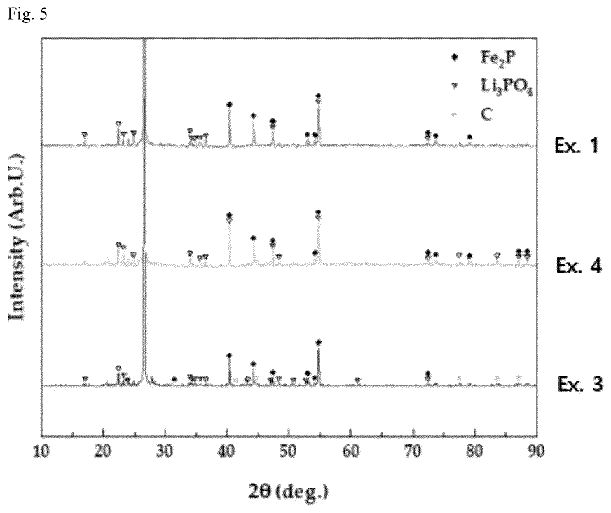

To identify the composition of the sample based on the heat treatment temperature and hydrogen content, XRD analysis was performed on the recovered material, and the results are presented in FIGS. 5 to 7.

As shown in FIG. 5, when the heat treatment temperature was 1000° C., lithium iron phosphate (LiFePO₄) was separated into iron phosphide (Fe₂P) and lithium phosphate (Li₃PO₄) in a hydrogen gas atmosphere including or consisting of 50 wt. % or more hydrogen. This indicates that under these conditions, lithium iron phosphate (LiFePO₄) can be effectively reduced and separated.

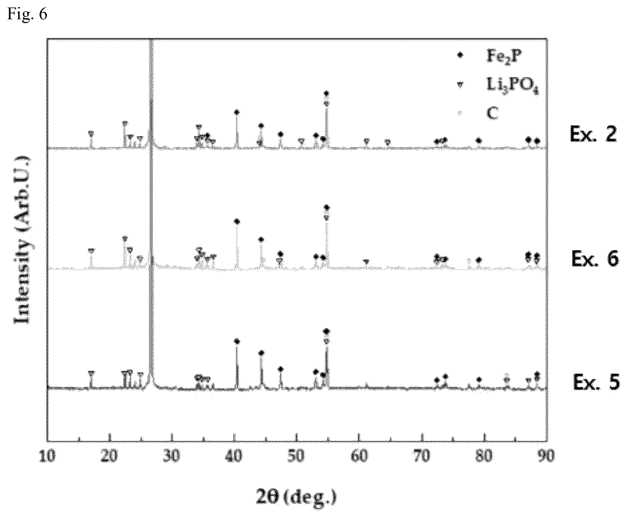

As shown in FIG. 6, when the heat treatment temperature was 1100° C., lithium iron phosphate (LiFePO₄) was separated into iron phosphide (Fe₂P) and lithium phosphate (Li₃PO₄) in a hydrogen gas atmosphere including or consisting of 50 wt. % or more hydrogen. This indicates that under these conditions, lithium iron phosphate (LiFePO₄) can be effectively reduced and separated.

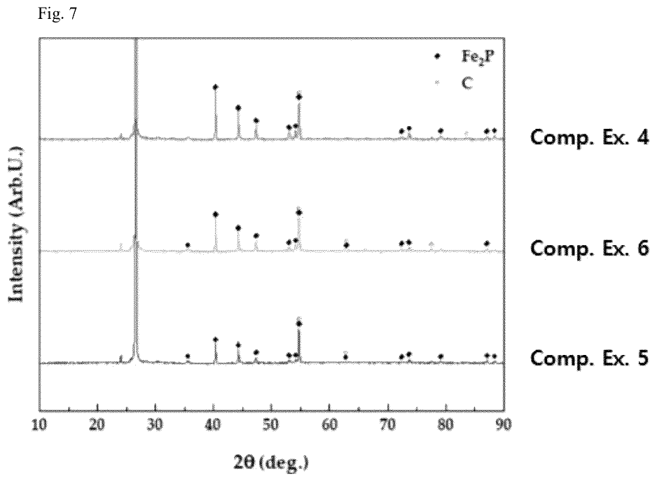

However, as shown in FIG. 7, when the heat treatment temperature was 1200° C., lithium iron phosphate (LiFePO₄) was separated into iron phosphide (Fe₂P) in a hydrogen gas atmosphere including or consisting of 50 wt. % or more hydrogen. This indicates that a loss of lithium phosphate (Li₃PO₄) occurred. Therefore, it may be concluded that at heat treatment temperatures of 1200° C. or higher, a loss of lithium (Li), a key metal, occurs, leading to a decrease in the efficiency of the heat treatment process.

As illustrated by the above experimental examples, it was identified that the method for recovering metals from batteries according to an embodiment of the present disclosure induces an effective reduction reaction of lithium iron phosphate (LiFePO₄), enabling the efficient recovery of lithium (Li), iron (Fe), and phosphorus (P) from LFP-based lithium-ion batteries, even in atmospheres having a lower hydrogen content. In particular, it was identified that the loss of lithium (Li), one of key metal targeted for recovery, may be minimized, thereby contributing to the establishment of a resource recycling system.

The features, structures, effects, and the like described in the exemplary embodiments above are included in at least one embodiment of the present disclosure and are not necessarily limited to a single embodiment. Furthermore, the features, structures, effects, and the like exemplified in each exemplary embodiment can be combined or modified in other embodiments by those skilled in the art to which the embodiments pertain. Therefore, such combinations and modifications should be construed as being within the scope of the present disclosure.

What is claimed is:

1. A method for recovering metals from a LiFePO₄ (LFP)-based lithium-ion battery, the method comprising:
providing an atmosphere comprising hydrogen gas; and
heat-treating the LFP-based lithium-ion battery in the atmosphere, wherein the heat-treating is performed at a temperature ranging from 1000° C. to less than 1200° C.

2. The method according to claim 1, wherein the atmosphere comprising hydrogen gas further comprises an inert gas.

3. The method according to claim 2, wherein the atmosphere comprising hydrogen gas comprises hydrogen in an amount of at least 50 wt. % based on the total weight of the atmosphere.

4. The method according to claim 1, wherein the heat-treating provides at least one recovered metal comprising iron phosphide (Fe₂P) and/or lithium phosphate (Li₃PO₄).

5. The method according to claim 1, wherein the LFP-based lithium-ion battery comprises a carbon source.

6. The method according to claim 5, wherein the carbon source comprises Carbon black, Acetylene black, Graphite, Carbon nanotube, and/or graphene.

7. The method according to claim 1, wherein the LiFePO4 (LFP)-based lithium-ion battery comprises a LiFePO4 (LFP)-based waste lithium-ion battery.

8. The method according to claim 1, wherein the method for recovering metals from the LFP-based lithium-ion battery further comprises
pretreating the LFP-based lithium-ion battery; and
crushing the pretreated LFP-based lithium-ion battery.

9. A metal recovered by the method for recovering metals from a LiFePO₄ (LFP)-based lithium-ion battery of claim 1.
